(19) United States
(12) Patent Application Publication
(10) Pub. No.: US 2024/0253580 A1
(43) Pub. Date: Aug. 1, 2024

(54) Vehicle Modular Support Assembly

(71) Applicant: BamBeds LLC., Lompoc, CA (US)

(72) Inventor: Ben Krumholz, Lompoc, CA (US)

(21) Appl. No.: 18/427,534

(22) Filed: Jan. 30, 2024

Related U.S. Application Data
(60) Provisional application No. 63/441,972, filed on Jan. 30, 2023.

(51) Int. Cl. B60R 13/01

(52) U.S. Cl. CPC B60R 13/01; B60R 2013/018

(57) ABSTRACT

An adjustable modular support assembly for a vehicle includes a first support board having a first substantially planar body including a first support face and a second support face. The first support board also includes first and second opposed side edges, first and second opposed end edges, and four corners. Each of the four corners are disposed between one side edge and one end edge. The first substantially planar body defines a lateral axis and a longitudinal axis. The adjustable modular support assembly also includes a second support board having a second substantially planar body including a first support face and a second support face. The second support board also has first and second opposed side edges, first and second opposed end edges, and four corners. At least one of the corners is adapted to receive a vehicle tailgate bulkhead and configured to be removably disposed in a truck bed.

### FIELD OF THE DISCLOSURE

The disclosure relates to an adjustable support assembly for a vehicle and more particularly to a modular adjustable bed support platform for a truck or sport utility vehicle.

### BACKGROUND

Pickup trucks, sport utility vehicles (SUV), and wagon-type automobiles are versatile, popular vehicles. Such vehicles generally have a fairly large utility space that may be used for seating (in the case of SUV and wagon-type automobiles), and/or for hauling cargo. In some cases, the utility space may be used for temporary housing, such as with camper toppers for pickup truck beds. More minimalist adventurers may even use the vehicles for camping by rolling out sleeping bags or temporary mattresses in the utility space. However, when using the utility space for sleep, much of the space is left unusable.

### SUMMARY OF THE DISCLOSURE

According to a first implementation, an adjustable modular support assembly for a vehicle includes a first support board, the first support board having a first substantially planar body including a first support face and a second support face. The first support board also includes first and second opposed side edges, first and second opposed end edges, and four corners. Each of the four corners are disposed between one side edge and one end edge. The first substantially planar body defines a lateral axis and a longitudinal axis. The adjustable modular support assembly also includes a second support board having a second substantially planar body including a first support face and a second support face. The second support board also has first and second opposed side edges, first and second opposed end edges, and four corners. Each of the four corners are disposed between one side edge and one end edge. The second substantially planar body defines a lateral axis and a longitudinal axis. At least one of the corners is adapted to receive a vehicle tailgate bulkhead and configured to be removably disposed in a truck bed.

According to a second implementation, an adjustable modular support assembly for a vehicle includes a first support board, the first support board having a first substantially planar body including a first support face and a second support face. The first support board also includes first and second opposed side edges, first and second opposed end edges, and four corners. Each of the four corners are disposed between one side edge and one end edge. The first substantially planar body defines a lateral axis and a longitudinal axis. The adjustable modular support assembly also includes a second support board having a second substantially planar body including a first support face and a second support face. The second support board also has first and second opposed side edges, first and second opposed end edges, and four corners. Each of the four corners are disposed between one side edge and one end edge. The second substantially planar body defines a lateral axis and a longitudinal axis. A first support includes a substantially planar first rail body, a first foot proximate a first end of the substantially planar first rail body and a second foot proximate a second end of the substantially planar first rail body. The substantially planar first rail body has a first edge that is adapted to at least partially support at least one of the first support board and the second support board.

According to a third implementation, an adjustable slider system for a vehicle includes, a first slider board, the first slider board having a substantially planar bottom including a first end edge and a second end edge, a first side edge and a second side edge, and an opening proximate the first end edge. The opening is adapted for grasping by a user and the first slider board is configured to fit beneath a first support board when the first support board is arranged in a vehicle. The adjustable slider system also includes a second slider board, the second slider board including a substantially planar bottom having a first end edge and a second end edge, a first side edge and a second side edge, and an opening proximate the first end edge. The opening is adapted for grasping by a user and the second slider board being configured to fit beneath the first support board and the second support board when the first support board and the second slider board are arranged in a vehicle.

According to a fourth implementation, an apparatus includes a pair of support boards, each support board having a pair of longitudinal sides along each of which hand holes are defined, a pair of lateral sides along each of which a hand hole is defined, and corners that are cutout to receive a vehicle tailgate bulkhead. The longitudinal sides of the support boards abut one another when installed in a vehicle to form a platform.

According to a fifth implementation, a modular support assembly kit for a vehicle includes a first support board, the first support board having a first substantially planar body including a first support face and a second support face. The first support board also includes first and second opposed side edges, first and second opposed end edges, and four corners. Each of the four corners are disposed between one side edge and one end edge. The first substantially planar body defines a lateral axis and a longitudinal axis. A second support board has a second substantially planar body including a first support face and a second support face. The second support board also includes first and second opposed side edges, first and second opposed end edges, and four corners. Each of the four corners are disposed between one side edge and one end edge. The second substantially planar body defines a lateral axis and a longitudinal axis. A third support board includes a third substantially planar body having a first support face and a second support face. The third support board also includes first and second opposed side edges, first and second opposed end edges, and four corners. Each of the four corners are disposed between one side edge and one end edge. The third substantially planar body defines a lateral axis and a longitudinal axis. A length of a first side edge of the third support board is approximately half the length of a first side edge of the first support board.

According to a sixth implementation, an apparatus includes a pair of sliders for a vehicle. Each slider includes a base, an end wall, a first side wall, and a second side wall. The base includes a pair of lateral sides along one of which hand holes are defined and a pair of longitudinal sides one of which defines a cutout to receive a vehicle tailgate bulkhead. The end wall extends from the base opposite the hand holes, the first side wall extends from the base at one of longitudinal sides and is coupled to the end wall, and the second side wall extends from the base at another one of the longitudinal sides and is coupled to the end wall. The longitudinal sides of the bases abut one another when installed in the vehicle.

The foregoing implementations of an adjustable modular support assembly, an adjustable modular slider system, an apparatus, or a kit may further include any one or more of the following optional features, structures, and/or forms.

In some optional forms, all four corners of the first substantially planar body are adapted to receive a vehicle tailgate bulkhead, and all four corners of the second substantially planar body are adapted to receive a vehicle tailgate bulkhead.

In other optional forms, at least one corner of the first substantially planar body comprises a radiused edge, a first angled edge that connects the radiused edge to the end edge and a second angled surface that connects the radiused edge to the side edge.

In other optional forms, the at least one corner further comprises a third angled edge that connects the radiused edge to the second angled edge, the third angled edge and the first angled edge being substantially perpendicular to one another.

In other optional forms, an opening is disposed proximate one of a side edge and an end edge of the first substantially planar body.

In other optional forms, a third support board has a third substantially planar body including a first support face and a second support face, first and second opposed side edges, first and second opposed end edges, and four corners, each of the four corners being disposed between one side edge and one end edge, the third substantially planar body defining a lateral axis and a longitudinal axis, and a length of a first side edge of the third support board is approximately half the length of a first side edge of the first support board.

In other optional forms, the first support board comprises a first opening proximate a first side edge and a second opening proximate a first end edge.

In other optional forms, at least two openings are disposed proximate the first side edge.

In other optional forms, the two openings are spaced by approximately one half the length of a side edge of the substantially planar body.

In other optional forms, a first opening is centered approximately ¼ the total length of the first side edge between a first end edge and a second end edge, and a second opening is centered approximately ¾ of the total length of the first side edge between the first end edge and the second end edge.

In other optional forms, the first edge of the substantially planar first rail body includes a plurality of pegs extending from the first edge in a direction opposite to one of the first foot and the second foot.

In other optional forms, at least two pegs in the plurality of pegs are spaced from one another by approximately half of a side edge length of the first support board.

In other optional forms, the first foot and the second foot have different heights.

In other optional forms, a second support rail includes a substantially planar second rail body, a first foot proximate a first end of the substantially planar second rail body and a second foot proximate a second end of the substantially planar second rail body. The substantially planar second rail body has a first edge that is adapted to at least partially support at least one of the first support board and the second support board.

In other optional forms, the first edge of the substantially planar second rail body includes a plurality of pegs extending from the first edge in a direction opposite to one of the first foot and the second foot.

In other optional forms, a tailgate extension board includes a substantially planar body a first end edge and a second end edge, and a plurality of slots proximate the first end edge.

In other optional forms, a first support foot includes a first peg that is adapted to be received in one of the plurality of slots.

In other optional forms, the first slider board has a maximum width that is approximately ½ the width of the first support board.

In other optional forms, a headboard has a pair of longitudinal sides and a pair of lateral sides along each of which a hand hole is defined. One of the longitudinal sides of the headboard is abuts with one of the longitudinal sides of one of the support boards when installed in the vehicle to form a platform.

In other optional forms, a tailgate extension and a pair of legs that each have a tongue. The tailgate extension includes a pair of longitudinal sides along one of which slots are defined that receive corresponding tongues of the legs, and a pair of hand holes are defined along each of the longitudinal sides of the tailgate extension. A pair of lateral sides each define a cutout to receive a vehicle tailgate bulkhead. One of the longitudinal sides of the tailgate abuts with one of the longitudinal sides of one of the support boards when installed in the vehicle to form the platform.

In another optional form, a third support board includes a pair of longitudinal sides along each of which hand holes are defined, and a pair of lateral sides along each of which hand holes are defined. Corners are cutout to receive the vehicle tailgate bulkhead.

In another optional form, each of the lateral sides of each of the support boards defines pairs of slots, and a pair of rails includes a plurality of tongues to be received within the corresponding slots.

In another optional form, each of the rails have a first height portion and a second height portion that corresponds to a contour of the vehicle.

In another optional form, each of the rails have a surface having a contour that corresponds to a contour of the vehicle.

In another optional form, the contour of the surface of the rails comprises a tapered surface.

In another optional form, the first side wall extends from the base to the cutout.

In another optional form, the first side wall is shorter than the second side wall.

According to a seventh implementation, a modular couch system includes a first substantially planar support board and a second substantially planar support board. A first rocker is configured to removably receive a first end of the first substantially planar support board and a first end of the second substantially planar support board. A second rocker is configured to removably receive a second end of the first substantially planar support board and a second end of the second substantially planar support board. When the first substantially planar support board and the second substantially planar support board are removably received on the first and second rockers, the first substantially planar support board forms a seat and the second substantially planar support board forms a back, the first substantially planar support board and the second substantially planar support board being angled relative to one another of between about 90 degrees and about 135 degrees.

The foregoing implementations of modular couch system may further include any one or more of the following optional features, structures, and/or forms.

In one optional form, the modular couch system includes a plurality of couch stiffeners, at least one of the couch stiffeners including a slot that fits substantially perpendicularly on the first rocker and the at least one couch stiffener is received in an opening in the first substantially planar support board when the first substantially planar support board is removably received on the first rocker such that the at least one couch stiffener structurally strengthens the removable reception of the first substantially planar support board on the first rocker.

### BRIEF DESCRIPTION OF THE DRAWINGS

While the specification concludes with claims particularly pointing out and distinctly claiming the subject matter, which is regarded as forming the present invention, the invention will be better understood from the following description taken in conjunction with the accompanying drawings.

FIG. 1 is a perspective view of a first implementation of an adjustable modular support assembly removably installed in a vehicle, the perspective view taken towards a rear of the vehicle.

FIG. 2 is a perspective view of the adjustable modular support assembly of FIG. 1, the perspective view taken towards a front of the vehicle.

FIG. 3 is a perspective view of the adjustable modular support assembly of FIGS. 1 and 2, with a tailgate of a vehicle open and an optional tailgate extension board installed.

FIG. 4 is a perspective view of the adjustable modular support assembly installed in the bed of a pickup truck, the perspective view taken towards a rear of the vehicle.

FIG. 5 is a perspective view of the adjustable modular support assembly of FIG. 4, with one support board partially removed and stacked.

FIG. 6A is a close up perspective view of the adjustable modular support assembly of FIG. 4, with a tailgate of a vehicle open and an optional tailgate extension board and supports installed.

FIG. 6B is another close up perspective view of the optional tailgate extension board and support of FIG. 6A.

FIG. 7 is a plan view of a support board of the adjustable modular support assembly of FIGS. 1-6.

FIG. 8 is a top perspective view of three support boards of the adjustable modular support assembly of FIGS. 1-6.

FIG. 9 is a top perspective view of two support boards of the adjustable modular support assembly of FIGS. 1-6 and an optional tailgate extension assembly.

FIG. 10 is a perspective view of a second implementation of an adjustable modular support assembly including support rails.

FIG. 11 is a perspective view of a third implementation of an adjustable modular support assembly including support rails.

FIG. 12 is a perspective view of support rails of the adjustable modular support assembly of FIG. 11.

FIG. 13 is a perspective view of an alternate implementation of a support rail.

FIG. 14 includes perspective views of alternate implementations of an adjustable modular support assembly and support rails that accommodate uneven vehicle utility space.

FIG. 15 is a perspective view of a slider storage system compatible with the adjustable modular support assemblies.

FIG. 16A is a top perspective view of a pair of slider boards of the slider storage system of FIG. 15.

FIG. 16B is a top plan view of the pair of slider boards of FIG. 16A.

FIG. 16C is an end view of the pair of slider boards of FIG. 16A.

FIG. 16D is a side view of the pair of slider boards of FIG. 16A.

FIG. 17 is a perspective view of a modular couch that uses support boards of the adjustable modular support assemblies.

FIG. 18 is a side view of a rocker panel of the couch of FIG. 17.

FIG. 19 is a side view of a stiffener of the couch of FIG. 17.

FIG. 20 is a plan view of one example of an adjustable modular support assembly kit.

FIG. 21 is a plan view of another example of an adjustable modular support assembly kit.

FIG. 22 is a top modular plan view of the adjustable modular support assembly of FIGS. 1-9 in a first configuration.

FIG. 23 is a top modular plan view of the adjustable modular support assembly of FIGS. 1-9 in a second configuration.

FIG. 24A is a top plan view of another implementation of an adjustable modular support assembly including support rails.

FIG. 24B is a top plan view of the implementation of FIG. 24A, with vehicle structure removed for ease of viewing.

FIG. 25A is a side view of the implementation of FIGS. 24A and 24B.

FIG. 25B is a side view of FIG. 25A with vehicle structure removed for ease of viewing.

FIG. 26A is a perspective view of another implementation of an adjustable modular support assembly.

FIG. 26B is another perspective view of the implementation of an adjustable modular support assembly of FIG. 26A, with some of the vehicle structure removed for ease of viewing.

FIG. 26C is an exploded perspective view of the adjustable modular support assembly of FIGS. 26A and 26B.

FIG. 27A is a perspective view of another implementation of an adjustable modular support assembly.

FIG. 27B is an exploded perspective view of the adjustable modular support assembly of FIG. 27A.

FIG. 28A is a perspective view of another implementation of an adjustable modular support assembly.

FIG. 28B is a side perspective view of the adjustable modular support assembly of FIG. 28A.

FIG. 28C is an exploded perspective view of the adjustable modular support assembly of FIG. 28A.

FIG. 28D is a top exploded view of the adjustable modular support assembly of FIG. 28A.

FIG. 29A is a top perspective view of another implementation of an adjustable modular support assembly.

FIG. 29B is a side perspective exploded view of the adjustable modular support assembly of FIG. 29A.

### DETAILED DESCRIPTION

Drivers are always looking to make better uses of vehicles. This is especially true for lovers of the outdoors. Often, outdoor lovers will use the vehicle as a mobile home. The clearest example of this is the recreational vehicle (RV) industry. RVs are essentially homes on wheels and can include every modern convenience of a stationary home. However, RVs can be large, cumbersome, and fuel inefficient, not to mention being very expensive to purchase. To minimize some of the drawbacks of full size RVs, some drivers attempt to convert utility vehicles, such as pickup trucks, vans, and sport utility vehicles (SUVs) into campers or temporary shelters. Such conversions can range from adding truck bed camper tops (complete with full beds and cooking facilities), to more minimalist approaches where a user simply rolls out a sleeping bag in the truck bed or utility area of a SUV or van.

In most cases, the utility space of the vehicle is not efficiently used, especially in the most minimalist of conversions where sleeping bags are rolled out in the truck bed or utility area. Essentially, the truck bed or utility area can either function as a bed (with a sleeping bag) or as a utility space to store and haul items, but not both. These choices generally lead to inefficient use of space because the area above the floor stored items is not usable, either because the floor stored items will be crushed by items resting on top of them, or because you cannot store items on top of a sleeping person. What is needed is a flexible storage system that makes better use of the available space in a truck bed or a utility space of a vehicle.

One having ordinary skill in the art, when reading the specification, will realize that any feature or structure described below with reference to one illustrated embodiment may be incorporated into any other illustrated or non-illustrated embodiment. Moreover, one having ordinary skill in the art, when reading the specification, will realize that any feature or structure illustrated and/or described with respect to one illustrated embodiment may be combined with any feature or structure illustrated and/or described with respect to any other illustrated embodiment.

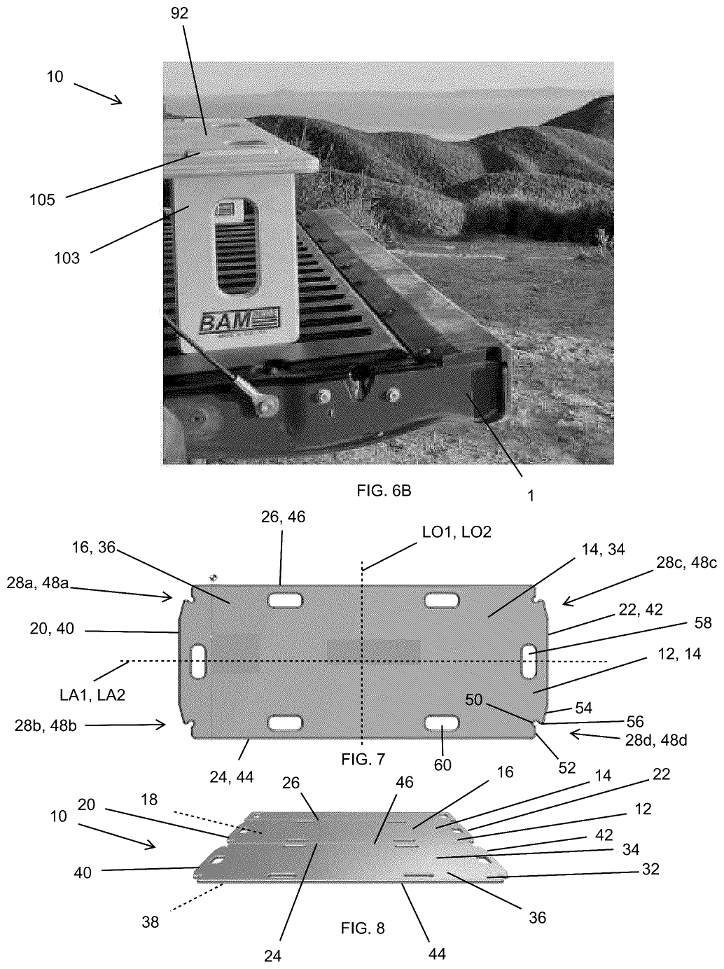

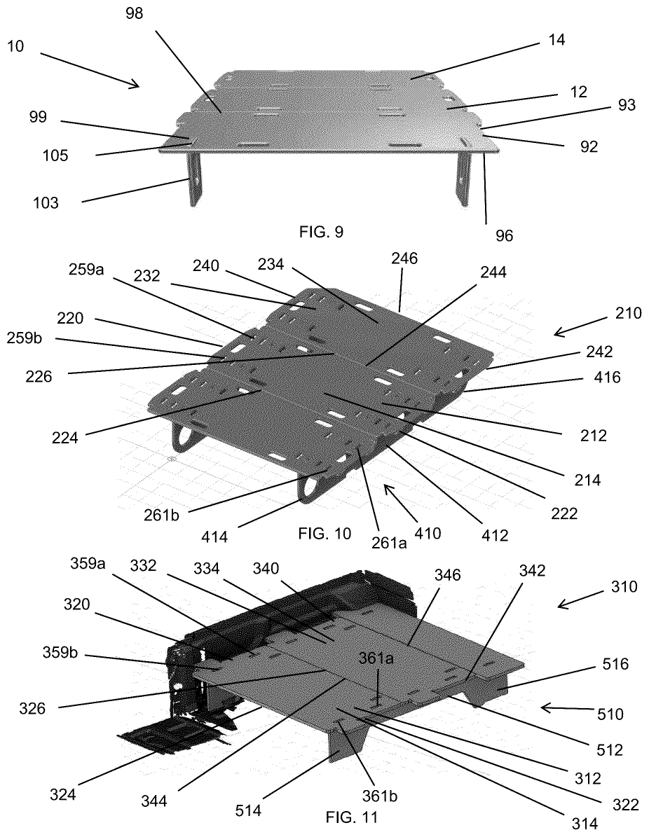

Turning now to FIGS. 1-9, an example flexible adjustable modular support assembly 10 for a vehicle 1 is illustrated. The vehicle 1 may be any type of vehicle such as a pickup truck, a sport utility vehicle (e.g., a Subaru or a Toyota 4 runner), a cross over, an off-road vehicle, a station wagon, a hatch back, etc. Generally, the vehicle 1 may include a utility area behind the driver and passenger seats. This utility area may form open storage space and/or the utility area may include further seats (which may be permanent or stowable). The adjustable modular support assembly 10 fits neatly in the utility area and makes efficient use of the utility area for storage and/or sleeping areas.

The adjustable modular support assembly 10 includes a first support board 12, the first support board 12 having a first substantially planar body 14 including a first support face 16 and a second support face 18. The first support board 12 also includes first and second opposed side edges 20, 22, first and second opposed end edges 24, 26, and four corners 28a, 28b, 28c, 28d (see, FIGS. 7 and 8). The side edges 20, 22 may be referred to as lateral sides and the end edges 24, 26 may be referred to as longitudinal sides, in some implementations, such as the implementation illustrated in FIGS. 1-9, the side edges 20, 22, may be shorter than the end edges 24, 26. In other implementations, the side edges 20, 22, may be longer than the end edges 24, 26. Each of the four corners 28a-d are disposed between one side edge 20, 22 and one end edge 24, 26. The first substantially planar body 14 defines a lateral axis LA1 and a longitudinal axis LO1.

The adjustable modular support assembly 10 also includes a second support board 32 having a second substantially planar body 34 including a first support face 36 and a second support face 38. The first support board 12 and/or the second support board 32 may be formed of any relatively rigid and strong material such as, for example, wood, particle board, plastic, rubber, metal, composite, etc. In some implementations, the first support board 12 and the second support board 32 may be formed of the same material. In other implementations, the first support board 12 and the second support board 32 may be formed of different materials. The first support board 12 and the second support board 32 may include the same features as one another in some implementations, such as the one shown in FIGS. 1-9. The first support board 12 and the second support board 32 may have different features, however in other implementations.

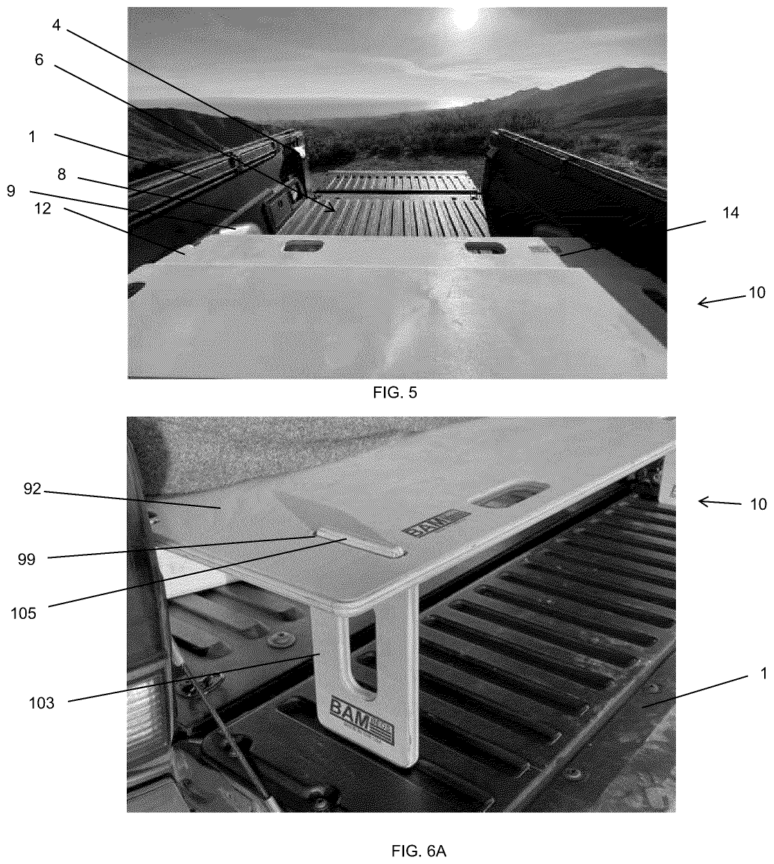

The second support board 32 also has first and second opposed side edges 40, 42, first and second opposed end edges 44, 46, and four corners 48a, 48b, 48c, 48d. Each of the four corners 48a-d are disposed between one side edge 40, 42 and one end edge 44, 46. The second substantially planar body 34 defines a lateral axis LA2 and a longitudinal axis LO2. In some implementations, at least one of the corners (e.g., one of the corners 28a-d of the first support board 12 or one of the corners 48a-d of the second support board 32) is adapted to receive a vehicle tailgate bulkhead 4 (see, FIG. 5) and each of the first support board 12 and the second support board 32 are configured to be removably disposed in a truck bed or utility area 6 of a vehicle 1. In other implementations, two, three, or all four of the corners 28a-d or 48a-d may be adapted to receive a vehicle tailgate bulkhead 4. The support boards 12 and/or 32 may receive the bulkhead 14 by going partially around the bulkhead 4 and/or by having a cutout to allow the support boards 12 and/or 32 to be received within the vehicle 1 and/or be relatively flat within the vehicle 1. Generally, at least part of the support board 12, 32, has a partially complementary shape to the bulkhead 4. One or more surfaces of the support boards 12 and/or 32 may or may not contact the bulkhead 4. The support boards 12 and/or 32 contacting the bulkhead 4 or otherwise contacting sides of the vehicle 1 may provide support such as lateral support for the support boards 12 and/or 32 within the vehicle 1 to keep the support boards 12 and/or 32 from sliding within the utility area 6 of the vehicle 1.

When disposed in a vehicle 1, the first support board 12 and/or the second support board 32 may rest on rails 8 formed in the vehicle 1, and/or rest on wheel wells 9 of the vehicle to elevate the first support board 12 and or the second support board 32 above a bottom of the vehicle utility area 6. This elevation advantageously forms a flat support surface/platform that may be used for a bed and also forms a storage space below for storing and/or carrying items without interfering with the support surface that may be referred to as a platform or sleeping surface. Additionally or alternatively, the flat support surface formed by the first support board 12 and/or the second support board 32 may be used for additional storage so that items located on top of the first support board 12 and/or the second support board 32 do not crush or damage items located below the first support board 12 and/or the second support board 32.

While only two corners 28a-d, 48a-d on either the first support board 12 or the second support board 32 may be sized and shaped to receive part of the vehicle tailgate bulkhead 4, in some implementations and as shown in FIG. 7, all four corners 28a-d of the first substantially planar body 14 are adapted to receive a vehicle tailgate bulkhead 4, and/or all four corners 48a-d of the second substantially planar body 34 are adapted to receive a vehicle tailgate bulkhead 4. The support boards 12, 32 may thus be symmetric about a longitudinal axis LO1, LO2 of the support boards 12, 32 and symmetric about a lateral axis LA1, LA2 of the support boards 12, 32. Such implementations make the support boards 12, 32 interchangeable and multi-directional, which advantageously removes the need for fitting a particular end of the first support board 12 or the second support board 32 to the vehicle tailgate bulkhead 4, and thus, the first support board 12 and/or the second support board 32 become “reversible” in the sense that the first support board 12 and/or the second support board 32 will fit against the vehicle tailgate bulkhead 4 in multiple orientations.

As discussed above, in some implementations, each of the corners 28a-d, 48a-d are arranged to receive the vehicle tailgate bulkhead 4. While only one corner 28d will be discussed for the sake of brevity and ease of viewing, all corners 28a-d, 48a-d may include the following structure. As illustrated in FIG. 7, the corner 28d of the first substantially planar body 13 comprises a radiused edge 50, a first angled edge 52 that connects the radiused edge 50 to the end edge 24 and a second angled surface 54 that connects the radiused edge 50 to the side edge 22.

In some implementations, the corner 28d further comprises a third angled edge 56 that connects the radiused edge 50 to the second angled edge 54, the third angled edge 56 and the first angled edge 52 being substantially perpendicular to one another and forming a recess that accepts the vehicle tailgate bulkhead 4.

In some implementations, the support boards 12, 32 include a side opening 58 as shown in FIG. 7 that may be disposed proximate a side edge 22, 42, and an end opening 60 that may be disposed proximate an end edge 24 of the first substantially planar body 14. Similar openings may be present in the second substantially planar body 34. The side opening 58 and the end opening 60 may function as and/or may be referred to as hand holds or hand holes for a user when setting up or tearing down the first support board 12 and/or the second support board 32. The side opening 58 and the end opening 60 may have alternate functions as discussed further below.

In some implementations, the adjustable modular support assembly 10 includes a third support board 62 (FIG. 1) that may be identical to the first support board 12 and/or to the second support board 32. Any features of the first support board 12 and/or the second support board 32 may be present on the third support board 62 and will not be further discussed herein for the sake of brevity.

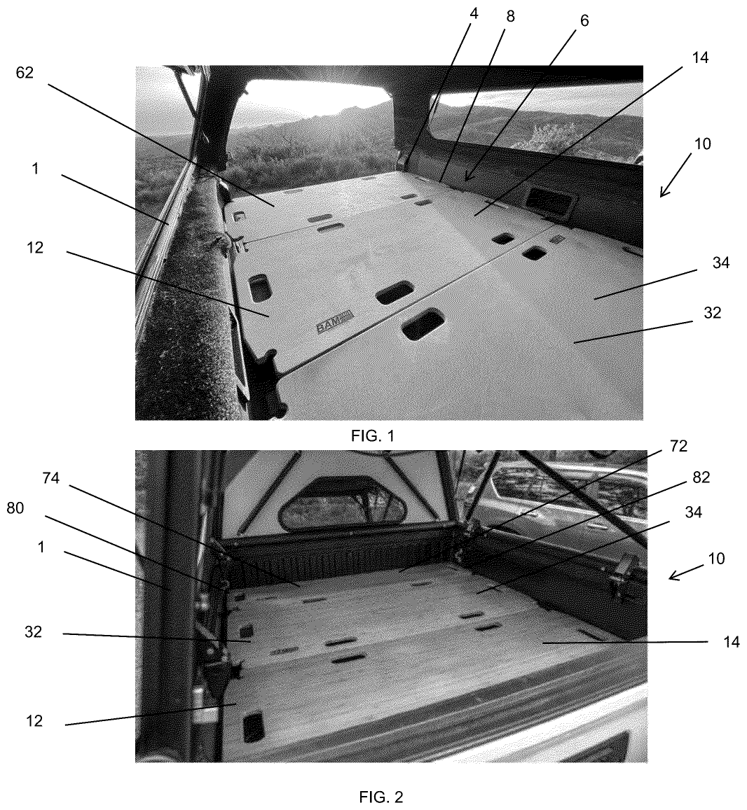

In other implementations, the adjustable modular support assembly 10 may include a headboard 72 (FIG. 2) that may include a headboard substantially planar body 74 including a first headboard support face and a second headboard support face. The headboard substantially planar body 74 may include first and second opposed side edges 80, 82, first and second opposed end edges, and four corners, as discussed above with respect to the first support board 12 and the second support board 32. The headboard substantially planar body 74 may define a lateral axis and a longitudinal axis, as discussed above with respect to the first support board 12 and the second support board 32. A length of a first side edge 80 of the headboard 72 may be approximately half the length of a first side edge 20 of the first support board 12. The length of the first side edge 20 and/or the length of the second side edge 82 may be any size based on the vehicle in which the adjustable modular support assembly 10 is used, however. The headboard 72 advantageously allows the adjustable modular support assembly 10 to fit into short bed type pickup trucks when the tailgate is closed (such as a Toyota Tacoma® shortbed truck) when three full size support boards are too long. The side edge 80, 82 of the headboard 72 may advantageously abut with one of the end or longitudinal sides 24, 26 of the first support board 12 or the end or longitudinal sides 44, 46 of the second support board 32 when installed in the vehicle 1 to form a platform.

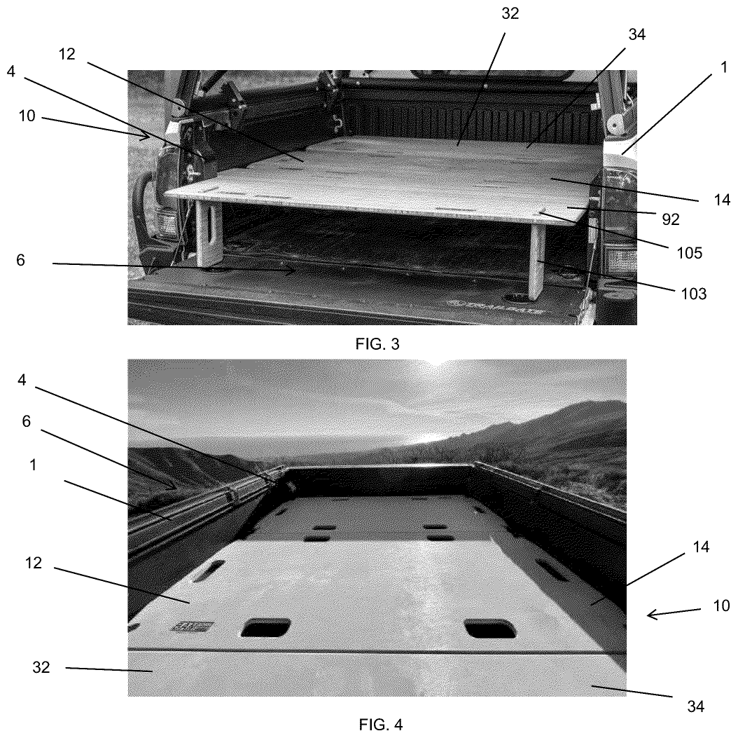

In some implementations, the adjustable modular support assembly 10 includes a tailgate extension board 92 (FIGS. 3, 6A, 6B, and 9) that includes a substantially planar body 94 having a first end edge 96 and a second end edge 98, and a plurality of slots 99 proximate the first end edge 96. The adjustable modular support assembly 10 may include a first support foot 103 that includes a first tongue or peg 105 that is adapted to be received in one of the plurality of slots 99. The tailgate extension board 92 and the support foot 103 allow the adjustable modular support assembly 10 to optionally lengthen, when a tailgate of the vehicle is open, to further optimize or increase usable space.

The tailgate extension board 92 may optionally include a pair of hand holes along each of the sides of the tailgate extension board 92. Similar to the first support board 12 and the second support board 32, the sides of the tailgate extension board 92 may define a cutout 93 to receive the vehicle tailgate bulkhead 4. However, in contrast with the first or second support board 12, 32, the cutout 93 may be located along the side edge, rather than at a corner. When installed, one of the ends of the tailgate extension board 92 may abut with one of the ends of one of the first or second support board 12, 32 when installed in the vehicle to form the platform.

Turning now to FIGS. 10-14, second and third implementations of an example modular support assembly 210, 310, are illustrated. Where having structure similar to that of the implementation of FIG. 1-9, such structure in FIGS. 10-14 will not be discussed for the sake of brevity. The implementations of FIGS. 10-14 advantageously may be used in vehicles without an internal support rail or slot in the utility space. Any feature or structure described in the implementation of FIGS. 1-9 may be combined with any implementation illustrated in FIGS. 10-14.

Similar to the first implementation, the second and third implementations of an adjustable modular support assembly 210, 310 for a vehicle include a first support board 212, 312. The first support board 212, 312 has a first substantially planar body 214, 314 including first and second opposed side edges 220, 222, 320, 322 and first and second opposed end edges 224, 226, 324, 326.

The adjustable modular support assembly 210, 310 also includes a second support board 232, 332 having a second substantially planar body 234, 334 including first and second opposed side edges 240, 242, 340, 342 and first and second opposed end edges 244, 246, 344, 346.

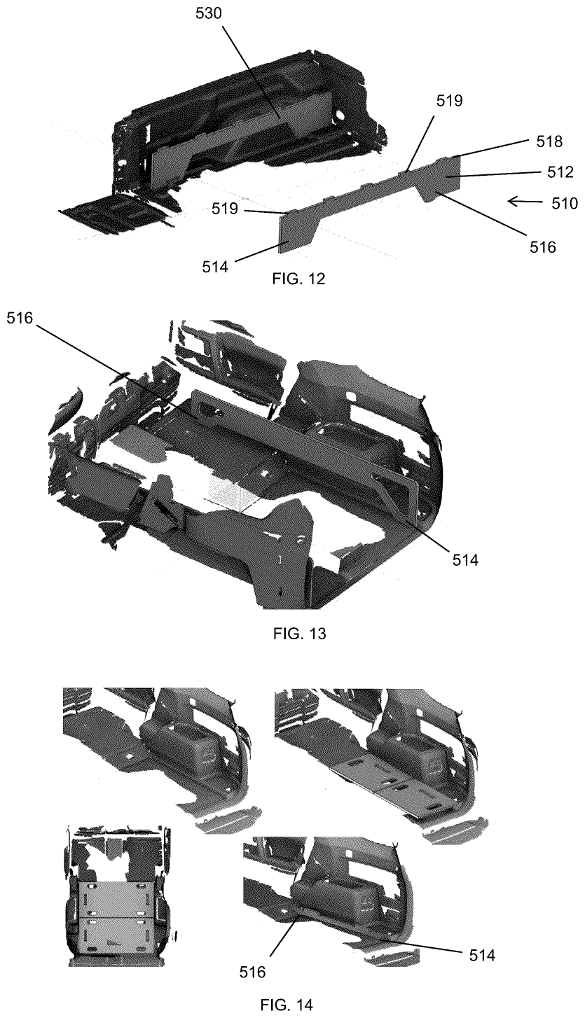

The modular support assembly 210, 310 may include a first support rail 410, 510 includes a substantially planar first rail body 412, 512, a first foot 414, 514 proximate a first end of the substantially planar first rail body 412, 512 and a second foot 416, 516 proximate a second end of the substantially planar first rail body 412, 512. The substantially planar first rail body 412, 512 has a first or top edge 518 (see FIG. 12) that is adapted to at least partially support at least one of the first support board 212, 312 and the second support board 232, 332.

One of the first support board 212, 312 and the second support board 232, 332 comprises a first opening 259a, 359a and a second opening 259b, 359b proximate the first side edge 220, 320 and a third opening 261a, 361a and a fourth opening 261b, 361b proximate the second side edge 222, 322. The support boards 212, 214 of the modular support assembly 210 of FIG. 10 includes four of each of the openings 259a, 259b, 261a, 261b that are laterally spaced from one another in the implementation shown. The plurality of each of the openings 259a, 259b, 261a, 261b enables the rails 412, 414 to be coupled to the support boards 212, 214 at different spacing/widths from one another depending on the design of the vehicle in which the modular support assembly 210 is used, for example.

In some implementations, the first side opening 259a, 359a and the second side opening 259b, 359b are spaced by approximately one half the length of the first side edge 220, 320 of the first substantially planar body 214, 314.

Similarly, the third side opening 261a, 361a and the fourth side opening 261b, 361b are spaced by approximately one half the length of the side edge 222, 322 of the first substantially planar body 214, 314.

In some implementations, the first side opening 259a, 359a is centered approximately ¼ the total length of the first side edge 220, 320 between the first end edge 324 and a second end edge 326, and the second side opening 259b, 359b is centered approximately ¾ of the total length of the first side edge 220, 320 between the first end edge 324 and the second end edge 326.

Focusing now on the third implementation as the following structures are more easily seen and as shown in FIG. 12, the first edge 518 of the substantially planar first rail body 512 includes a plurality of pegs 519 extending from the first edge 518 in a direction opposite to one of the first foot 514 and the second foot 516.

In some implementations, at least two pegs in the plurality of pegs 519 are spaced from one another by approximately half of the side edge 320 length of the first support board 312.

By spacing the pegs 519 and the first side openings 259a, 359a and the second side openings 259b, 359b by approximately one half of the side edge 220, 320 the first and second support boards 212, 312, 232, 332 may be moved by half of a board length when repositioning, which opens half a board length at either end, where a headboard, or a tailgate extension may be located.

In order to level changing utility floors, the first foot 514 and the second foot 516 may have different heights, as illustrated in FIGS. 13 and 14. In other implementations, where the vehicle floor is flat, the first foot 514 and the second foot 516 may be joined by a flat surface to form one continuous bottom edge. In yet other implementations, spacers (not shown) may be used beneath one or more of the feet 514, 516 to adjust a height of the platform.

Returning now to FIG. 12, a second support rail 530 includes some or all of the structures and features described above with respect to the first support rail 510.

While the implementations illustrated in FIGS. 10-14 include first and second support rails, other implementations may include any number of support rails. For example, in some implementations, a single support rail may be used, in other implementations, three support rails (one on each side and one between the two sides) may be used, in still other implementations, more than three rails may be used. Furthermore, in other implementations, individual side rails may comprise two or more pieces.

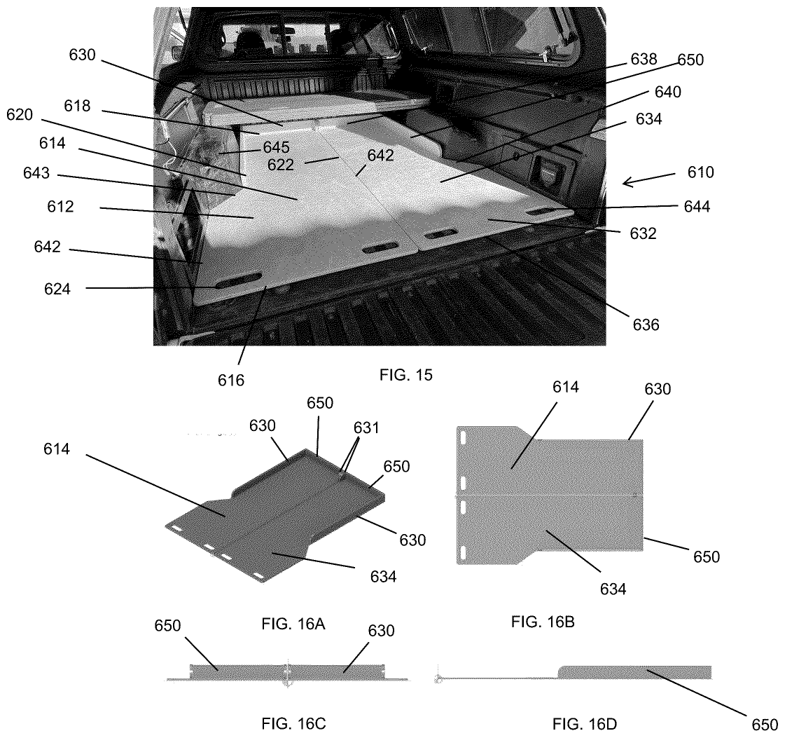

Turning now to FIGS. 15 and 16, an adjustable slider system 610 is illustrated that may be used with the adjustable modular support assemblies described above, or as a stand alone system. The adjustable slider system 610 includes a first slider board 612 that has a substantially planar bottom 614 for easy sliding within a utility space of a vehicle. The substantially planar bottom 614 includes a first end edge 616 and a second end edge 618, a first side edge 620 and a second side edge 622, and an opening 624 proximate the first end edge 620. The substantially planar bottom 614 may be referred to as a base. The end edges 616, 618 may be referred to as lateral sides. The opening 624 may be referred to as a hand hole. The opening 624 is adapted for grasping by a user and the first slider board 612 is configured to fit beneath a first support board of the adjustable modular support assembly when the first support board is arranged in a vehicle. The adjustable slider system 610 also includes a second slider board 632. The second slider board 632 includes a substantially planar bottom 634 having a first end edge 636 and a second end edge 638, a first side edge 640 and a second side edge 642, and an opening 644 proximate the first end edge 640. The side edges 640, 642 may be referred to as longitudinal sides. The side edges 640 include a cutout 643 in the implementation shown to receive the wheel well 645 of the vehicle. The opening 644 is adapted for grasping by a user and the second slider board 632 is configured to fit beneath the first support board and a second support board of the adjustable modular support assembly when the first support board is arranged in a vehicle. The first and second slider boards 612, 632 may have a raised wall 630, 650, distal to the first end edges 620, 640. The raised wall 650 may be referred to as an end wall. The raised wall 630 may be referred to as a side wall. A small guide wall 631 may be formed on an opposite side from the side wall 630. The small guide wall 631 may facilitate alignment between the first slider board 612 and the second slider board 632. The raised walls 630, 650 may capture items stored in the first and second slider boards 612, 632 when the first and second slider boards 612, 632 are pulled out to access the items.

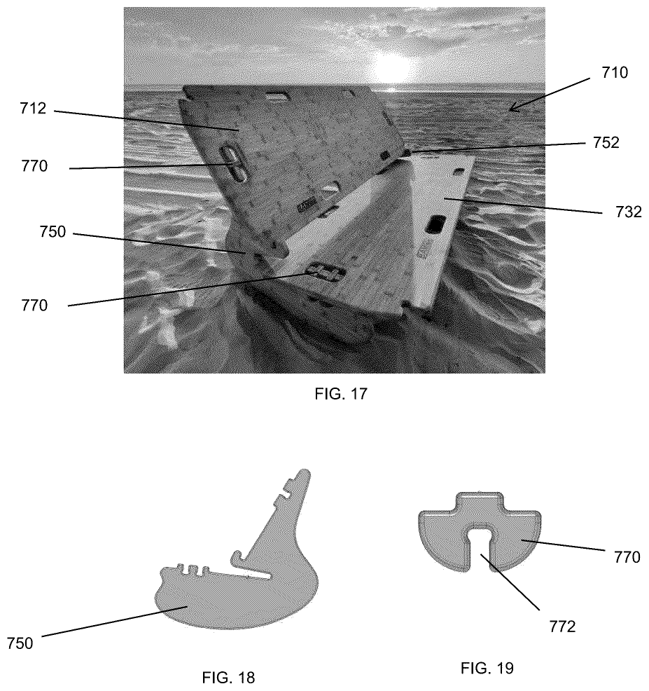

Turning now to FIGS. 17-19, a modular couch system 710 is illustrated that may use the support boards of the adjustable modular support system described above. The modular couch system 710 includes a first substantially planar support board 712 and a second substantially planar support board 732 that are identical to the substantially planar support boards described above. A first rocker 750 is configured to removably receive a first end of the first substantially planar support board 712 and a first end of the second substantially planar support board 732. A second rocker 752 is configured to removably receive a second end of the first substantially planar support board 712 and a second end of the second substantially planar support board 732. When the first substantially planar support board 712 and the second substantially planar support board 732 are removably received on the first and second rockers 750, 752, the first substantially planar support board 712 forms a substantially horizontal seat and the second substantially planar support board 732 forms an angled back support. The first substantially planar support board 712 and the second substantially planar support board 732 are angled relative to one another of between about 90 degrees and about 135 degrees.

One or more couch stiffeners 770 may cooperate with the first and second substantially planar support boards 712, 732 to secure the first and second substantially planar support boards 712, 732 to the first and second rockers 750, 752. The couch stiffener 770 includes a slot 772 that fits substantially perpendicularly on the first rocker 750 and the couch stiffener 770 is received in an opening in the first substantially planar support board 712 when the first substantially planar support board 712 is removably received on the first rocker 750 such that the couch stiffener 770 structurally strengthens the removable reception of the first substantially planar support board 712 on the first rocker750. Stiffeners similar to the couch stiffeners 770 may also be used in any implementation having support rails, such as the support rail implementations discussed above.

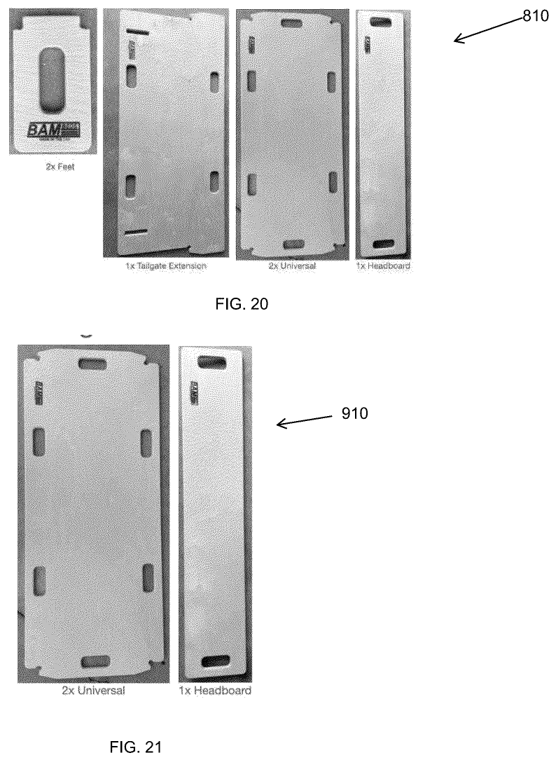

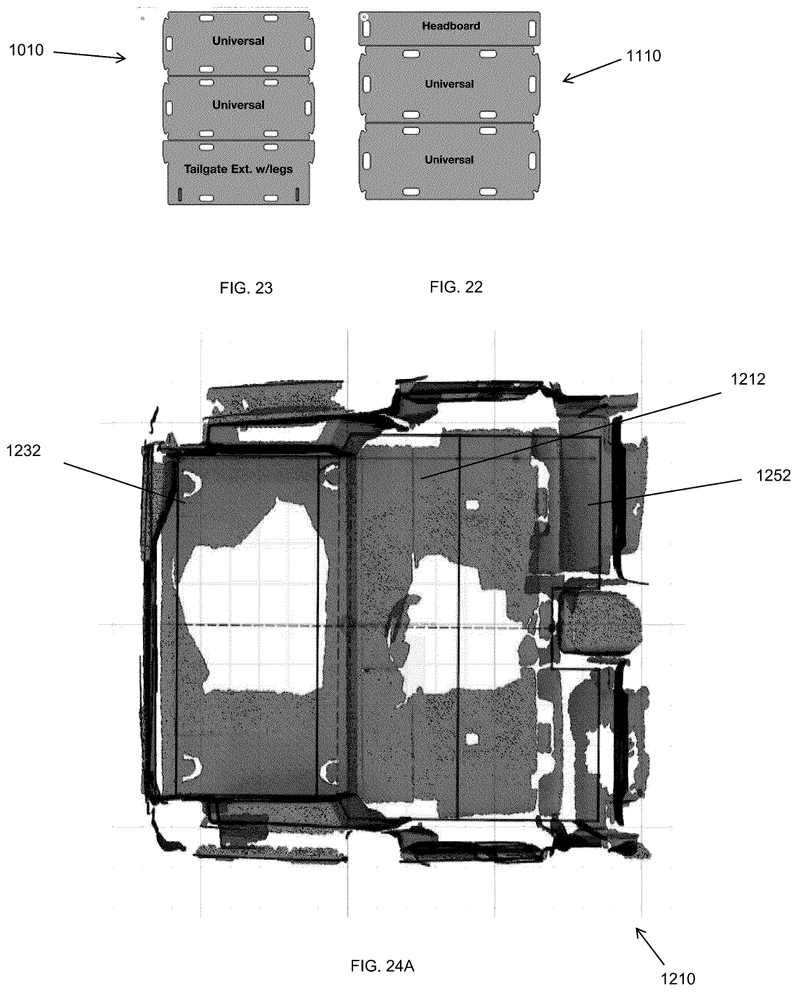

Turning now to FIGS. 20-23, the adjustable modular support assemblies described above may be packaged as kits 810, 910, 1010, 1110, for ease of delivery and storage.

Turning now to FIGS. 24A, 24B, 25A, and 25B, another implementation of an adjustable modular support assembly 1210 for a vehicle include a first support board 1212. The first support board 1212 has a first substantially planar body 1214 including first and second opposed side edges 1220, 1222 and first and second opposed end edges 1224, 1226.

The adjustable modular support assembly 1210 also includes a second support board 1232 having a second substantially planar body 1234 including first and second opposed side edges 1240, 1242 and first and second opposed end edges 1244, 1246.

The adjustable modular support assembly 1210 may also include a third support board 1252 having a third substantially planar body 1254 including first and second opposed side edges 1260, 1262 and first and second opposed end edges 1264, 1266.

The first support board 1212 may include a side notch 1221 that is configured to accept a portion of a wheel well of a vehicle to increase stability of the platform.

The third support board 1252 may include a center cutout 1253 configured to be slightly larger than a portion of a center console of a vehicle to allow access to the contents of the center console when the platform is installed.

The modular support assembly 1210 may include a first support rail 1410 having a substantially planar first rail body 1412 a first foot 1414 proximate a first end of the substantially planar first rail body 1412 and a second foot 1416 proximate a second end of the substantially planar first rail body 1412. The substantially planar first rail body 1412 has a first or top edge 1518 that is adapted to at least partially support at least one of the first support board 1212, the second support board 1232, and the third support board 1252.

The modular support assembly 1210 may include a second support rail (not shown) that is substantially the same as the first support rail 1410.

The first (and second) support rail 1410 may include a cantilever portion 1520 that projects outward beyond the second foot 1416 and hangs over a rear seat wheel well when installed in a vehicle. The implementation of FIGS. 24A. 24B, 25A, and 25B may be particularly advantageous in sport utility vehicles, such as the Ford Bronco®.

Turning now to FIGS. 26A-26C, a fourth implementation of an example modular support assembly 2010 is illustrated. Where having structure similar to that of the implementation of FIG. 1-9, such structure in FIGS. 26A-26C will not be discussed for the sake of brevity. The implementation of FIGS. 26A-26C advantageously may be used in vehicles without an internal support rail or slot in the utility space. Any feature or structure described in the implementation of FIGS. 1-25 may be combined with any implementation illustrated in FIGS. 26A-26C.

The fourth implementation of an adjustable modular support assembly 2010 for a vehicle includes a first support board 2012. The first support board 2012 has a first substantially planar body 2014 including first and second opposed side edges 2020, 2022 and first and second opposed end edges 2024, 2026.

The adjustable modular support assembly 2010 also includes a second support board 2032 having a second substantially planar body 2034 including first and second opposed side edges 2040, 2042 and first and second opposed end edges 2044, 2046.

The modular support assembly 2010 may include a first support rail 2410 includes a substantially planar first rail body 2412, a first foot 2414 proximate a first end of the substantially planar first rail body 2412 and a second foot 2416 proximate a second end of the substantially planar first rail body 2412. In the implementation of FIGS. 26A-26C, the first foot 2414 and the second foot 2416 have different elevations or heights to accommodate different flooring heights in a vehicle. The substantially planar first rail body 2412 has a first or top edge 2518 that is adapted to at least partially support at least one of the first support board 2012 and the second support board 2032.

At least one of the first support board 2012 and the second support board 2032 comprises a first opening 2059a proximate the first side edge 2020, 2040 and a second opening 2061a proximate the second side edge 2022, 2042. The openings 2059a, 2061a, enable the rail 2410 to be coupled to the support boards 2012, 2032.

The adjustable modular support assembly 2010 may also include a third support board 2062 having a second substantially planar body 2064 including first and second opposed side edges 2080, 2082 and first and second opposed end edges 2084, 2086.

Like the first support board 2012 and the second support board 2032, the third support board 2062 may comprise a first opening 2059a proximate the first side edge 2080 and a second opening 2061a proximate the second side edge 2082. The openings 2059a, 2061a, enable the rail 2410 to be coupled to the third support boards 2012, 2040. Additionally, the third support board 2062 may comprise laterally oriented openings 2063a, 2063b, 2063c, 2063d, which allow further connection between the third support board 2062 and the rail 2410. More specifically, lateral clips 2065a, 2065b, may extend through one or more of the laterally oriented openings 2063a, 2063b, 2063c, 2063d, and also receive the top edge 2518 of the first rail body 2412 in a slot formed in the lateral clip 2065a, 2065b.

The third support board 2062 may also comprise a connecting slot 2067a, 2067b formed the first end edge 2084. In other embodiments, the connecting slots 2067a, 2067b may be formed in the second end edge 2086. Moreover, while not illustrated in FIGS. 26A-26C, one or more of the first support board 2012 and the second support board 2032 may comprise connecting slots. The connecting slots 2067a, 2067b may be complementary in size and shape to receive a connecting tab 2069a, 2069b formed on another support board, or on an extension board 2092.

The top edge 2518 of the substantially planar first rail body 2412 includes a plurality of pegs 2519 extending from the first edge 2518 in a direction opposite to one of the first foot 2514 and the second foot 2516.

In order to level changing utility floors, the first foot 2414 and the second foot 2416 may have different heights, as illustrated in FIGS. 26B and 26C. In other implementations, where the vehicle floor is flat, the first foot 2414 and the second foot 2416 may be joined by a flat surface to form one continuous bottom edge.

A second support rail illustrated in FIGS. 26A-26C may include some or all of the structures and features described above with respect to the first support rail 2410.

The second support board 2032 may include one ore more cut-outs 2071a, 2071b in one or more of the side edges 2040, 2042. The cut-outs 2071a, 2071b may accommodate internal protrusions of the vehicle, for example, protrusions formed by a wheel well. While the cut-outs 2071a, 2071b are illustrated in the second support board 2032, the first support board 2012 or the third support board 2062 may include cut-outs in other implementations.

Similar to the second support board 2032, the third support board 2062 may include one or more notches 2073a, 2073b in one or more of the side edges 2080, 2082. The notches 2073a, 2073b may have two steps, as illustrated in FIG. 26C. In other implementations, other notch shapes may be employed. The notches 2073a, 2073b are formed to receive inner protrusions or structures in the vehicle, such as wheel wells, or third row seat brackets.

In the implementation of FIGS. 26A-26C, two corners 2028a, 2028b, are formed as convex curves. The convex curves mirror an interior of the vehicle near the vehicle tailgate bulkhead.

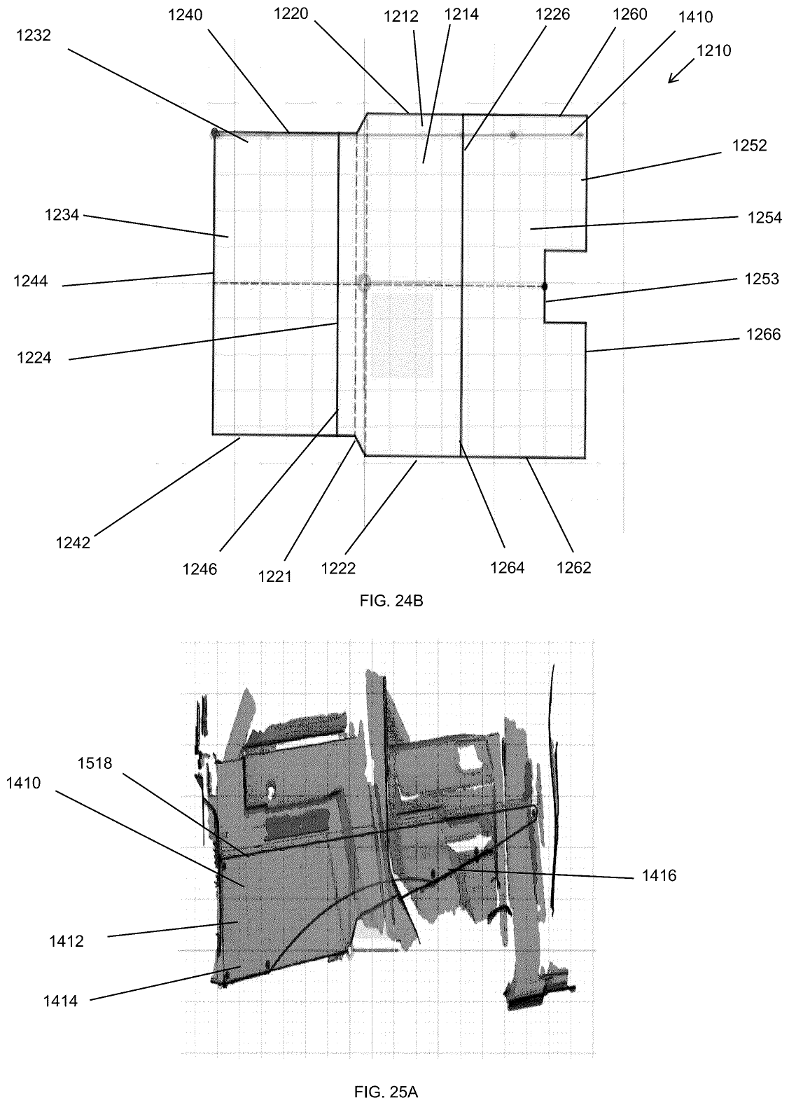

Turning now to FIGS. 27A and 27B, a fifth implementation of an example modular support assembly 3010 is illustrated. Where having structure similar to that of the implementation of FIGS. 1-9 and 26A-26C such structure in FIGS. 27A and 27B will not be discussed for the sake of brevity. The implementation of FIGS. 27A and 27B advantageously may be used in vehicles without an internal support rail or slot in the utility space. Any feature or structure described in the implementation of FIGS. 1-26 may be combined with any implementation illustrated in FIGS. 27A and 27B.

The fifth implementation of an adjustable modular support assembly 3010 for a vehicle include a first support board 3012. The first support board 3012 has a first substantially planar body 3014 including first and second opposed side edges 3020, 3022 and first and second opposed end edges 3024, 3026.

The adjustable modular support assembly 3010 also includes a second support board 3032 having a second substantially planar body 3034 including first and second opposed side edges 3040, 3042 and first and second opposed end edges 3044, 3046.

The modular support assembly 3010 may include a first support rail 3410 includes a substantially planar first rail body 3412, a first foot 3414 proximate a first end of the substantially planar first rail body 3412 and a second foot 3416 proximate a second end of the substantially planar first rail body 3412. The substantially planar first rail body 3412 has a first or top edge 3518 that is adapted to at least partially support at least one of the first support board 3012 and the second support board 3032.

At least one of the first support board 3012 and the second support board 3032 comprises a first opening 3059a proximate the first side edge 3020, 3040 and a second opening 3061a proximate the second side edge 3022, 3042. The openings 3059a, 3061a, enable the rail 3410 to be coupled to the support boards 3012, 3032.

The top edge 3518 of the substantially planar first rail body 3412 includes a plurality of pegs 3519 extending from the first edge 3518 in a direction opposite to one of the first foot 3514 and the second foot 3516.

A second support rail illustrated in FIGS. 27A and 27B may include some or all of the structures and features described above with respect to the first support rail 3410.

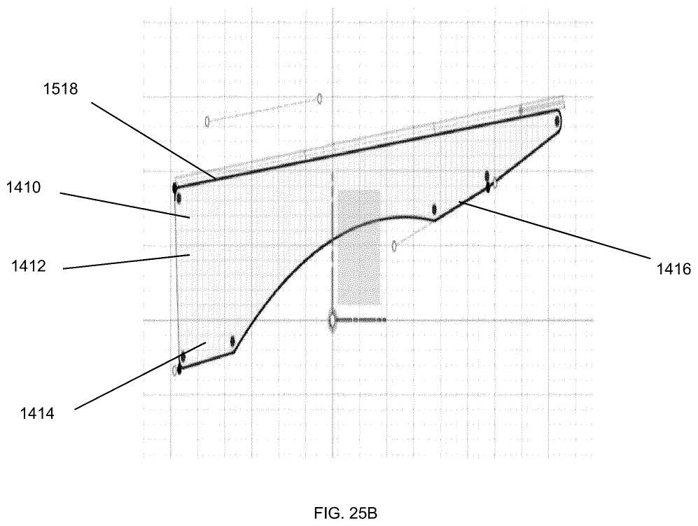

Turning now to FIGS. 28A-28D, a sixth implementation of an example modular support assembly 4210 is illustrated. Where having structure similar to that of the implementation of FIGS. 1-9 and FIGS. 26-27, such structure in FIGS. 28A-28D will not be discussed for the sake of brevity. The implementation of FIGS. 28A-28D advantageously may be used in vehicles without an internal support rail or slot in the utility space. Any feature or structure described in the implementation of FIGS. 1-27 may be combined with any implementation illustrated in FIGS. 28A-28D.

The sixth implementation of an adjustable modular support assembly 4010 for a vehicle include a first support board 4012. The first support board 4012 has a first substantially planar body 4014 including first and second opposed side edges 4020, 4022 and first and second opposed end edges 4024, 4026.

The adjustable modular support assembly 4010 also includes a second support board 4032 having a second substantially planar body 4034 including first and second opposed side edges 4040, 4042 and first and second opposed end edges 4044, 4046.

The modular support assembly 4010 may include a first support rail 4410 including a substantially planar first rail body 4412, a first foot 4414 proximate a first end of the substantially planar first rail body 4412 and a second foot 4416 proximate a second end of the substantially planar first rail body 4412. An intermediate foot 4415 may also be included. The substantially planar first rail body 4412 has a first or top edge 4518 that is adapted to at least partially support at least one of the first support board 4012 and the second support board 4032.

At least one of the first support board 4012 and the second support board 4032 comprises a first opening 4059a proximate the first side edge 4020, 4040 and a second opening 4061a proximate the second side edge 4022, 4042. The openings 4059a, 4061a, enable the rail 4410 to be coupled to the support boards 4012, 4040.

The adjustable modular support assembly 4010 may also include a third support board 4062 having a second substantially planar body 4064 including first and second opposed side edges 4080, 4082 and first and second opposed end edges 4084, 4086.

Like the first support board 4012 and the second support board 4032, the third support board 4062 may comprise a first opening 4059a proximate the first side edge 4080 and a second opening 4061a proximate the second side edge 4082. The openings 4059a, 4061a, enable the rail 4410 to be coupled to the third support boards 4012, 4040.

Lateral clips 4065a, 4065b, may receive the top edge 4518 of the first rail body 4412 in an slot formed in the lateral clip 4065a, 4065b and the lateral clips 4065a, 4065b may have an upper surface that forms an additional support for the first support board 4012 or the second support board 4032, or the third support board 4062.

The third support board 4062 may also comprise a connecting slot 4067a, 4067b formed the first end edge 4084. In other embodiments, the connecting slots 4067a, 4067b may be formed in the second end edge 4086. Moreover, while not illustrated in FIGS. 28A-28D, one or more of the first support board 4012 and the second support board 4032 may comprise connecting slots. The connecting slots 4067a, 4067b may be complementary in size and shape to receive a connecting tab 4069a, 4069b formed on another support board, or on an extension board 2092.

The top edge 4518 of the substantially planar first rail body 4412 includes a plurality of pegs 4519 extending from the first edge 4518 in a direction opposite to one of the first foot 4414 and the second foot 4416.

A second support rail illustrated in FIGS. 28A-28D may include some or all of the structures and features described above with respect to the first support rail 4410.

Turning now to FIGS. 29A and 29B, a seventh implementation of an example modular support assembly 5010 is illustrated. Where having structure similar to that of the implementation of FIGS. 1-9 and 25-28, such structure in FIGS. 29A and 29B will not be discussed for the sake of brevity. The implementation of FIGS. 29A and 29B advantageously may be used in vehicles without an internal support rail or slot in the utility space. Any feature or structure described in the implementation of FIGS. 1-28 may be combined with any implementation illustrated in FIGS. 29A and 29B.

The seventh implementation of an adjustable modular support assembly 5010 for a vehicle include a first support board 5012. The first support board 5012 has a first substantially planar body 5014 including first and second opposed side edges 5020, 5022 and first and second opposed end edges 5024, 5026.

The adjustable modular support assembly 5010 also includes a second support board 5032 having a second substantially planar body 5034 including first and second opposed side edges 5040, 5042 and first and second opposed end edges 5044, 5046. In some implementations, the side edges 5040, 5042 may form a tongue and groove or overlapping connection with a side edge 5080, 5082 of another support board.

The modular support assembly 5010 may include a plurality of support rails including a first support rail 5410 includes a substantially planar first rail body 5412 and a first foot 5414 or bottom edge. The substantially planar first rail body 5412 has a first or top edge 5518 that is adapted to at least partially support at least one of the first support board 5012 and the second support board 5032.

At least one of the first support board 5012 and the second support board 5032 comprises a first opening 5059a proximate the first side edge 5020, 5040 and a second opening 5061a proximate the second side edge 5022, 5042. The openings 5059a, 5061a, enable the rail 5410 to be coupled to the support boards 5012, 5040.

The adjustable modular support assembly 5010 may also include one or more intermediate or third support boards 5062 having a second substantially planar body 5064 including first and second opposed side edges 5080, 5082 and first and second opposed end edges 5084, 5086.

Like the first support board 5012 and the second support board 5032, the third support board 5062 may comprise a first opening 5059a proximate the first side edge 5080 and a second opening 5061a proximate the second side edge 5082. The openings 5059a, 5061a, enable the rail 5410 to be coupled to the third support boards 5062.

The top edge 5518 of the substantially planar first rail body 5412 one or more pegs 5519 extending from the first edge 5518 in a direction opposite to the first foot 5514.

A plurality of support rails illustrated in FIGS. 29A and 29B, which may include some or all of the structures and features described above with respect to the first support rail 5410.

The first or second support board 5012, 5032 may include one ore more cut-outs 5071a, 5071b in one or more of the side edges 5022, 5040. The cut-outs 5071b may accommodate internal protrusions of the vehicle, for example, protrusions formed by a wheel well. While the cut-outs 2071a, may accommodate a tail gate bulkhead.

The implementation illustrated in FIGS. 29A and 29B differs from other implementations in that the support boards 5022, 5032, and 5062 are oriented lengthwise in the utility area of the vehicle.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An adjustable modular support assembly for a vehicle, the support assembly comprising:
a first support board, the first support board having a first substantially planar body including a first support face and a second support face, first and second opposed side edges, first and second opposed end edges, and four corners, each of the four corners being disposed between one side edge and one end edge, the first substantially planar body defining a lateral axis and a longitudinal axis; and
a second support board, the second support board having a second substantially planar body including a first support face and a second support face, first and second opposed side edges, first and second opposed end edges, and four corners, each of the four corners being disposed between one side edge and one end edge, the second substantially planar body defining a lateral axis and a longitudinal axis,
wherein at least one corner is adapted to receive a vehicle tailgate bulkhead and configured to be removably disposed in a truck bed.

2. The adjustable modular support assembly of claim 1, wherein all four corners of the first substantially planar body are adapted to receive a vehicle tailgate bulkhead, and all four corners of the second substantially planar body are adapted to receive a vehicle tailgate bulkhead.

3. The adjustable modular support assembly of claim 1, wherein at least one corner of the first substantially planar body comprises a radiused edge, a first angled edge that connects the radiused edge to the end edge and a second angled surface that connects the radiused edge to the side edge.

4. The adjustable modular support assembly of claim 3, wherein the at least one corner further comprises a third angled edge that connects the radiused edge to the second angled edge, the third angled edge and the first angled edge being substantially perpendicular to one another.

5. The adjustable modular support assembly of claim 1, further comprising an opening proximate one of a side edge and an end edge of the first substantially planar body.

6. The adjustable modular support assembly of any claim 1, further comprising a third support board, the third support board having a third substantially planar body including a first support face and a second support face, first and second opposed side edges, first and second opposed end edges, and four corners, each of the four corners being disposed between one side edge and one end edge, the third substantially planar body defining a lateral axis and a longitudinal axis,
wherein a length of a first side edge of the third support board is approximately half the length of a first side edge of the first support board.

7. The adjustable modular support assembly of claim 1, wherein the first end edge includes one of a connecting slot or a connecting tab.

8. The adjustable modular support assembly of claim 7, wherein the second end edge includes the other of the connecting slot or the connecting tab, the connecting tab being configured to be received in the connecting slot.

9. (canceled)

10. (canceled)

11. The adjustable modular support assembly of claim 1, wherein one of the first and second opposed side edges includes a notch having two steps.

12. (canceled)

13. (canceled)

14. An adjustable modular support assembly for a vehicle, the support assembly comprising:
a first support board, the first support board having a first substantially planar body including a first support face and a second support face, first and second opposed side edges, first and second opposed end edges, and four corners, each of the four corners being disposed between one side edge and one end edge, the first substantially planar body defining a lateral axis and a longitudinal axis;
a second support board, the second support board having a second substantially planar body including a first support face and a second support face, first and second opposed side edges, first and second opposed end edges, and four corners, each of the four corners being disposed between one side edge and one end edge, the second substantially planar body defining a lateral axis and a longitudinal axis; and
a first support rail, the first support rail comprising a substantially planar first rail body, a first foot proximate a first end of the substantially planar first rail body and a second foot proximate a second end of the substantially planar first rail body, the substantially planar first rail body including a first edge that is adapted to at least partially support at least one of the first support board and the second support board.

15. The adjustable modular support assembly of claim 14, wherein the first support board comprises a first opening proximate a first side edge and a second opening proximate a first end edge.

16. The adjustable modular support assembly of claim 15, further comprising at least two openings proximate the first side edge.

17. The adjustable modular support assembly of claim 16, wherein the two openings are spaced by approximately one half the length of a side edge of the substantially planar body.

18. The adjustable modular support assembly of claim 17, wherein a first opening is centered approximately ¼ the total length of the first side edge between a first end edge and a second end edge, and a second opening is centered approximately ¾ of the total length of the first side edge between the first end edge and the second end edge.

19. The adjustable modular support assembly of claim 14, wherein the first edge of the substantially planar first rail body includes a plurality of pegs extending from the first edge in a direction opposite to one of the first foot and the second foot.

20. The adjustable modular support assembly of claim 19, wherein at least two pegs in the plurality of pegs are spaced from one another by approximately half of a side edge length of the first support board.

21-23. (canceled)

24. The adjustable modular support assembly of claim 14, further comprising a tailgate extension board, the tailgate extension board comprising a substantially planar body a first end edge and a second end edge, and a plurality of slots proximate the first end edge.

25. (canceled)

26. The adjustable modular support assembly of claim 14, further comprising a first slider board, the first slider board including a substantially planar bottom having a first end edge and a second end edge, a first side edge and a second side edge, and an opening proximate the first end edge, the opening being adapted for grasping by a user and the first slider board being configured to fit beneath at least one of the first support board and the second support board when the first support board and the second support board are arranged in a vehicle.

27. (canceled)

28. (canceled)

29. The adjustable modular support assembly of claim 14, wherein one of the first support board and the second support board further comprises a laterally oriented opening, and a lateral clip extends through the laterally oriented opening and also receives the first edge of the first rail body in a slot formed in the lateral clip.

30-40. (canceled)

41. A modular support assembly kit for a vehicle, the kit comprising:
a first support board, the first support board having a first substantially planar body including a first support face and a second support face, first and second opposed side edges, first and second opposed end edges, and four corners, each of the four corners being disposed between one side edge and one end edge, the first substantially planar body defining a lateral axis and a longitudinal axis;
a second support board, the second support board having a second substantially planar body including a first support face and a second support face, first and second opposed side edges, first and second opposed end edges, and four corners, each of the four corners being disposed between one side edge and one end edge, the second substantially planar body defining a lateral axis and a longitudinal axis, and
a third support board, the third support board having a third substantially planar body including a first support face and a second support face, first and second opposed side edges, first and second opposed end edges, and four corners, each of the four corners being disposed between one side edge and one end edge, the third substantially planar body defining a lateral axis and a longitudinal axis,
wherein a length of a first side edge of the third support board is approximately half the length of a first side edge of the first support board.

42-44. (canceled)
